(19) United States
(12) Patent Application Publication
(10) Pub. No.: US 2023/0313580 A1
(43) Pub. Date: Oct. 5, 2023

(54) BLOW MOLDED PIN FOR HINGE MECHANISM

(71) Applicant: Lifetime Products, Inc., Clearfield, UT (US)

(72) Inventors: Jeremy Ross Wendt, Clinton, UT (US); Kent David Ashby, Logan, UT (US); Kenneth William Taylor, Roy, UT (US); James Dale Hatch, South Ogden, UT (US)

(21) Appl. No.: 18/194,819

(22) Filed: Apr. 3, 2023

Related U.S. Application Data
(60) Provisional application No. 63/327,339, filed on Apr. 4, 2022.

(51) Int. Cl. E05D 5/10; E05D 3/02

(52) U.S. Cl. CPC E05D 5/10; E05D 3/02; E05D 2005/104; E05Y 2900/602

(57) ABSTRACT

In one example, an apparatus includes a blow molded structure with one or more parting lines. The blow molded structure includes a body portion that is an integral part of the blow molded structure, and a pin that is integral with the body portion, and a portion of the pin is spaced apart from the body portion of the blow molded structure so that a space is defined between the portion of the pin and the body portion.

### FIELD OF THE INVENTION

Example embodiments of the invention are directed to molded plastic elements, such as blow-molded elements and compression molded elements, as well as to devices, structures, and mechanisms, that may include these elements, without any limit or restriction as to the specific nature of any particular blow molded device, structure, or mechanism. Some particular embodiments are directed to relatively small, blow molded elements and/or compression molded elements, such as pins for example, that may, or may not, be included as an integral element of a larger blow molded plastic structure.

### BACKGROUND

Blow molding processes may be used to create a variety of different structures. For various manufacturing, and technical, reasons however, blow-molding processes have been limited to the production of structures that do not include unsupported, or only minimally supported, elements.

### ASPECTS OF SOME EXAMPLE EMBODIMENTS

Various disclosed embodiments generally relate to blow molded structures, as well as any other structures, devices, and mechanisms, that include blow molded elements and/or compression molded elements. Note that blow molded elements and compression molded elements, either or both of which may be included as integral parts of a blow molded structure, may be generally referred to herein as ‘molded’ elements. In general, molded elements according to some example embodiments may be integrally formed, during a molding process, as part of a blow molded structure.

One, non-limiting, example of a molded element, according to some example embodiments, is a pin that is configured and arranged so that the pin is only supported at its ends by an associated blow molded structure to which the pin is connected. Thus, except for its ends, the pin in this example embodiment may not be connected to, or in contact with, any other portion of the blow molded structure.

More generally, except for the location(s) where a molded element such as a pin may be connected to a blow molded structure, there may be open space separating the pin from the blow molded structure, such that the body, or at least a portion of the body, of the pin stands off a distance from a part of the blow molded structure. In embodiments, a molded element such as a pin may be supported at its ends, and may also be supported at one or more locations, or areas, between its ends.

A pin, as disclosed herein, need not have any particular length, or cross-sectional shape, or cross-sectional area. In some embodiments, the pin may have a generally circular cross-sectional shape, but that is not required. Because the pin may be integrally formed with the blow molded structure to which it is connected, the pin may have a hollow interior that communicates with a hollow portion or hollow interior of the blow molded structure. In other embodiments, a molded element, such as a pin for example, may be solid and may be formed by compression at the same time as the blow molded structure, of which the pin may be an integral part, is formed.

A blow molded structure may comprise multiple molded pins, including one or more solid pins and/or one or more hollow pins. Example blow molded structures that may comprise one or more molded pins include, but are not limited to, containers that define a volume, such as gear boxes, cargo boxes, tubs, and coolers. A cooler, which may comprise a blow-molded body that defines a volume, may also comprise insulation within each of the hollow walls, floor, and lid, of the blow-molded body. In some embodiments, a pin may comprise an element of a closure assembly that may include a latch configured to releasably engage the pin, for example. In other embodiments, a pin may comprise an element of a mechanism such as a hinge, for example, that may be used to rotatably connect two elements together. No particular implementation, or use, of a pin, or other molded element disclosed herein, is required however.

The embodiments disclosed herein do not constitute an exhaustive summary of all possible embodiments. It should be noted that nothing herein should be construed as constituting an essential or indispensable element of any invention or embodiment. Rather, and as the person of ordinary skill in the art will appreciate, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular technical problem(s). Nor should such embodiments be construed to implement, or be limited to implementation of, any particular technical effect(s).

Example embodiments may provide various advantages relative to conventional structures and devices. For example, a blow molded structure according to one or more embodiments may comprise one or more integral pins, one or more of which may comprise an element of a hinge mechanism, that may enable the implementation of a hinge mechanism with relatively fewer parts than are employed in conventional hinges. An embodiment of the invention may enable two or more blow molded structures to be rotatably, and releasably, connected to each other. An embodiment of the invention may enable an element of a hinge mechanism to be integrally formed with a structure that employs the hinge mechanism. Various other advantages of example embodiments will be apparent from this disclosure.

### BRIEF DESCRIPTION OF THE DRAWINGS

The appended drawings contain figures of example embodiments to further illustrate and clarify the above and other aspects, advantages and features of the present invention. It will be appreciated that these drawings depict only example embodiments of the invention and are not intended to limit its scope. The invention will be described and explained with additional specificity and detail through the use of the accompanying drawings in which:

FIG. 1 discloses an example apparatus, a box in this case, that includes a blow-molded pin, according to one embodiment.

FIG. 2 is a detail view of the example embodiment of FIG. 1, disclosing an example configuration and arrangement of a blow-molded pin.

FIG. 3 is an alternative view of the configuration shown in FIG. 2.

FIG. 4 discloses various operational positions of various portions of an example latch mechanism that interfaces with a blow-molded pin, according to an example embodiment.

FIG. 5 is a detail view of an example blow-molded pin, according to one embodiment.

FIG. 6 discloses the example blow-molded pin of FIG. 5, as engaged with a latch mechanism, according to one embodiment.

FIG. 7 discloses a blow-molded pin, and support element, according to one embodiment.

FIG. 8 discloses an example of a closure assembly engaged with a blow-molded pin, according to one embodiment.

FIG. 9 discloses an example support element attached to a structure, according to one embodiment.

FIG. 10 is a front view of a portion of an apparatus that includes a pair of support elements, and a closure assembly, according to one embodiment.

FIG. 11 is an exploded view of an example closure assembly, including a latch and a handle, according to one embodiment.

FIG. 12 is an alternative view of the example closure assembly of FIG. 11.

FIG. 13 is a top view of an example panel with one or more integral blow molded pins, and one or more integral hinge portions, according to one example embodiment.

FIG. 14 includes detail views of the structure, and fit, of a pin and a hinge portion, according to one example embodiment.

FIG. 15 discloses some example structures releasably connected to each other by way of one or more hinge portions and pins, according to one example embodiment.

FIG. 16 discloses further example structures releasably connected to each other by way of one or more hinge portions and pins, according to one example embodiment.

FIG. 17a is a top/front view that discloses aspects of a hinge geometry of an apparatus, according to one example embodiment.

FIG. 17b is a bottom perspective view that discloses aspects of a hinge geometry of an apparatus, according to one example embodiment.

FIG. 17c is a section view of the examples of FIGS. 17a and 17b, according to one embodiment.

### DETAILED DESCRIPTION OF EXAMPLE EMBODIMENTS

Embodiments of the present invention generally relate to blow molded structures that may include one or more integral molded elements that may be connected to, but spaced apart from, a main body, or other main portion, of a blow molded structure. Such integral elements, which may be compression molded or blow molded, may take the form of a pin, for example, and may be may be relatively small in size as compared with the blow molded structure in which the integral element is formed.

A. General Aspects of Some Example Structures

Example molded structures within the scope of this disclosure may be made of any suitable material, including plastics such as high-density polyethylene (HDPE). Depending upon the embodiment, the molded structures may be formed by any of blow-molding, compression molding, roto-molding, injection molding, thermoforming, vacuum molding, twin sheet molding, drape molding, or any group of one or more of these. The molded structures may be hollow, or at least include one or more hollow portions. Such hollow portions may include, and/or be defined in whole or in part by, one or more tack-offs. As well, and discussed in further detail below, molded structures within the scope of this disclosure may include one or more compression molded elements that are integral with the molded structure.

In any of the disclosed embodiments, a blow molded structure may be in the form of a unitary, one-piece structure that is substantially hollow and/or includes a substantially hollow portion. Thus, such embodiments may have an interior that is partly, or completely, hollow. Such embodiments may also include, disposed in the interior, one or more depressions, sometimes referred to as “tack-offs.” In such embodiments, these tack-offs may be integrally formed as part of a unitary, one-piece structure during the blow-molding process. The depressions may extend from a first interior surface of the blow molded structure towards a second interior surface of the blow molded structure. The ends of one or more depressions may contact or engage the second surface, or the ends of one or more of the depressions may be spaced apart from the second surface by a distance. In some instances, one or more depressions on a first interior surface may be substantially aligned with corresponding depressions on a second interior surface, and one or more depressions on the first interior surface may contact one or more corresponding depressions on the second interior surface or, alternatively, one or more depressions on the first interior surface may be spaced apart from corresponding depressions on the second interior surface. In still other instances, depressions that contact each other and depressions that are spaced apart from each other may both be present in a blow molded structure. The depressions may be sized and configured to strengthen and/or reinforce the blow molded structure.

As well, example embodiments may include one or more parting lines which may comprise vestigial portions of plastic present on a molded part after molding has been completed. In general, the vestigial portions of plastic comprise plastic that has escaped into a joint between portions of a mold. Additionally, or alternatively, a finished molded part may include visible indicia, such as parting lines for example, where vestigial portions of plastic have been removed from a molded part, such as by grinding for example.

The vestigial portions of plastic, and the corresponding parting lines, may be formed, and/or located at, a junction of the halves of a mold, or mold portion, that is used to make the molded part. That is, the vestigial portions of plastic may be formed when two portions of a mold come together during a molding process.

Example embodiments may include elements such as parting lines. In some particular embodiments, a parting line may extend along part, or all, of a length of a molded element such as a pin. Embodiments may include one or more parting lines formed by compression molding, and/or one or more parting lines formed by blow molding.

B. Aspects of Some Example Embodiments

B.1 Closure with Molded Pin

At least some example embodiments are directed to a pin such as may comprise an element of a closure assembly. Such a closure assembly may be employed, for example, in a structure, such as a box, tub, or a cooler for example, that includes a hinged lid, and the closure assembly may comprise a latch mechanism that may be used to releasably secure the lid to the body of the box. The pin may be compression molded, or blow molded but, in either case, the pin may comprise an integral element of a lid, formed together with the lid as a single piece integrated structure when the lid is created using a blow molding process, or other molding process.

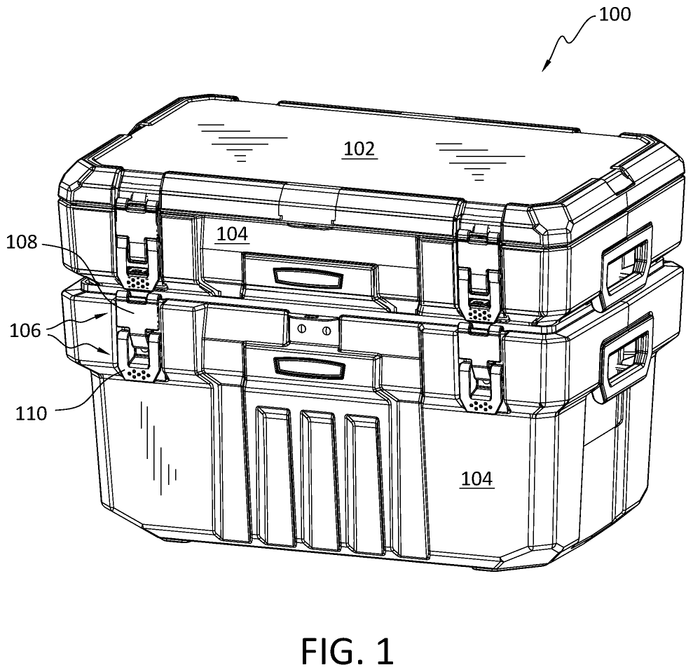

With reference now to FIG. 1, further details are provided concerning an example embodiment of the invention. As shown, a container 100, such as a box, tub, or a cooler for example, may include a lid 102 that is configured to attach to a container body 104. The lid 102 and the container body 104 may both be blow molded plastic, such as HDPE (high density polyethylene) for example, structures that comprise a respective unified, single piece, construction. Depending upon the embodiment, one or more integral elements of the lid 102 and/or of the container body 104 may be either compression molded, or blow molded. In some embodiments, the lid 102 may be configured so that it is completely removable from the container body 104. This configuration may enable a container body 104 to be partly received within another container body 104, as shown in FIG. 1.

To this end, example embodiments may comprise one or more closure assemblies 106 that enable the lid 102 to be removably attached to the container body 104. In some embodiments, four closure assemblies 106 may be provided, two along each lengthwise side of the lid 102. However, no particular number, or arrangement, of closure assemblies 106 is required. In another embodiment, at least one closure assembly 106 may be provided on each of the four sides of the lid 102. In still another embodiment, one side of the lid 102 may be permanently attached to the container body 104 by one or more hinges, while an opposing side of the lid 102 is releasably connected to the container body 104 with one or more closure assemblies 106.

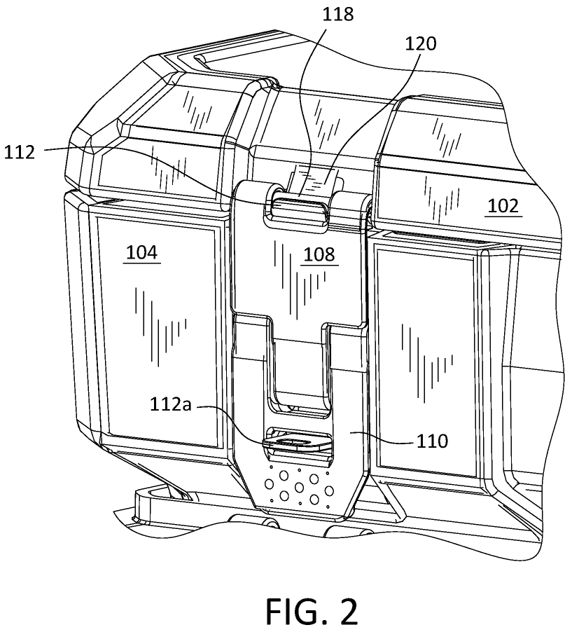

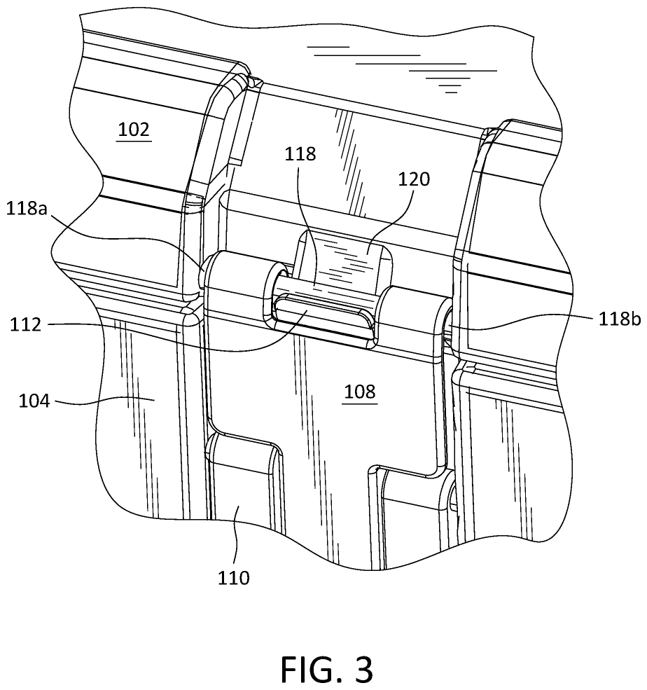

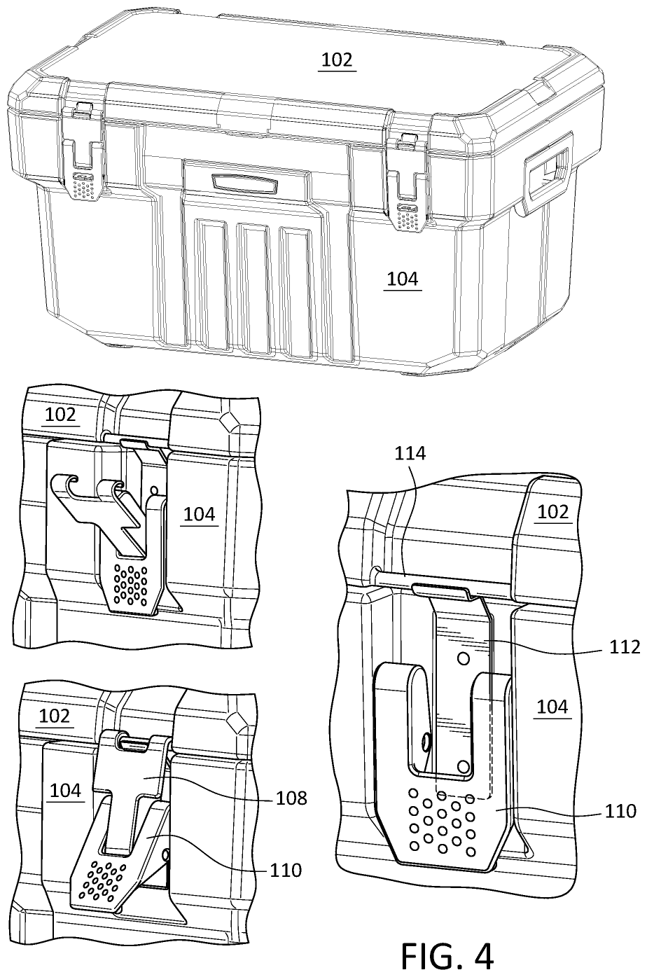

With reference now to FIGS. 1-4, each of the closure assemblies 106 may comprise a latch 108 rotatably connected to a handle 110 which may, in turn, be rotatably connected to the container body 104. The closure assembly 106 may further comprise a support element 112, which may be made of metal such as steel for example, that is attached to the container body 104 with one or more fasteners 113, such as screws, rivets, or bolts for example. In general, and as described in more detail below, the support element 112 may serve to provide structural support to, such as by contacting, an element of the lid 102, such as a pin 114 or 118 (discussed below) that is releasably engageable by the closure assembly 106. In some embodiments, the support element 112 may define an opening 112a configured to receive a shackle, or shank, of a lock (not shown) so that the lid 102 may be locked shut.

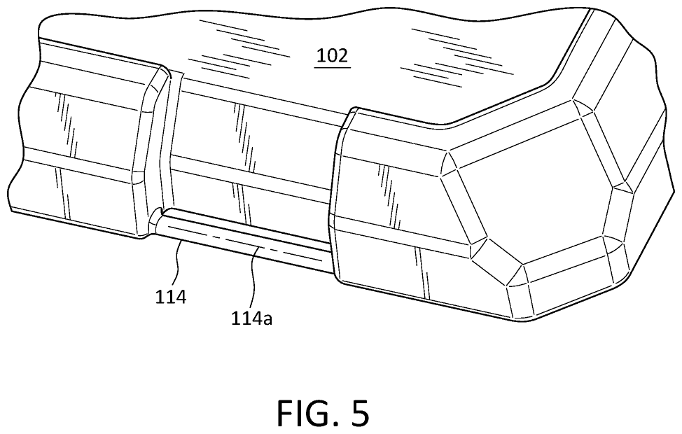

With reference to FIGS. 1-5, a blow molded structure, such as some embodiments of the lid 102 for example, may comprise one or more integral structures, such as a pin 114 for example, that are created during the formation of the blow molded structure. In general, a pin 114 may be configured and arranged to interface with a latch 108 of a closure assembly 106. By repositioning the handle 110 to which the latch 108 is rotatably connected, the latch 108 may be selectively engaged with, and selectively disengaged from, the pin 114.

In the particular embodiment illustrated in the Figures, the pin 114 may be formed in a mold at the same time as the lid 102 is being formed. The pin 114 may be compression molded and, thus, be solid. In other embodiments, the pin 114 may be blow molded and, thus, have a hollow interior that may, or may not, communicate with a hollow interior of the lid 102.

Whether the pin 114 is solid, or hollow, the pin 114 may comprise vestigial elements, and/or parting lines 114a, formed in whole or in part by a molding process, such as compression molding or blow molding. In some embodiments, the vestigial elements and/or parting line may run generally lengthwise along the pin 114.

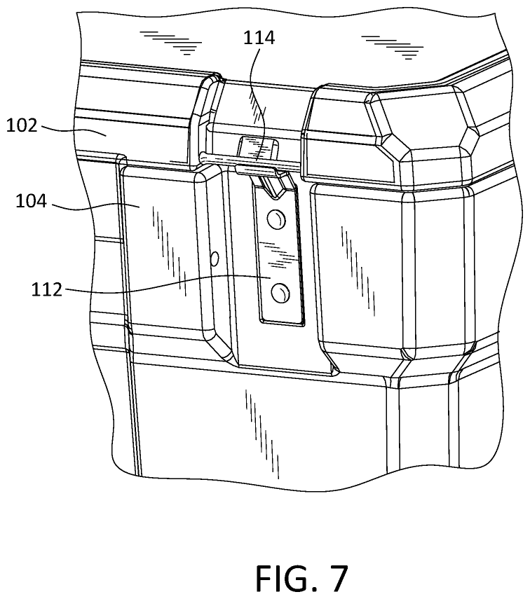

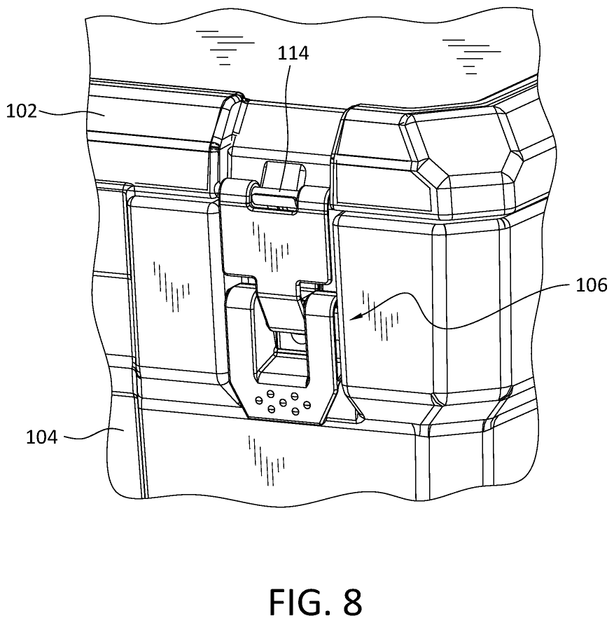

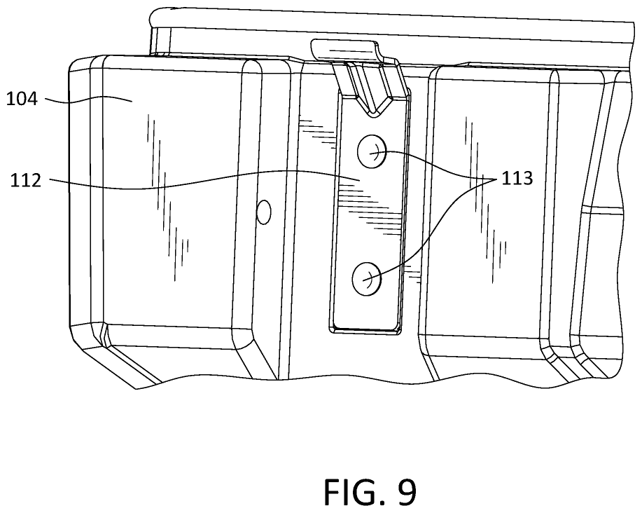

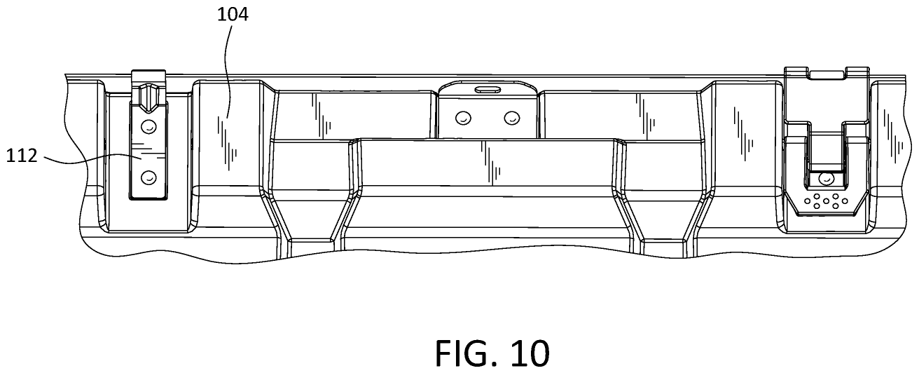

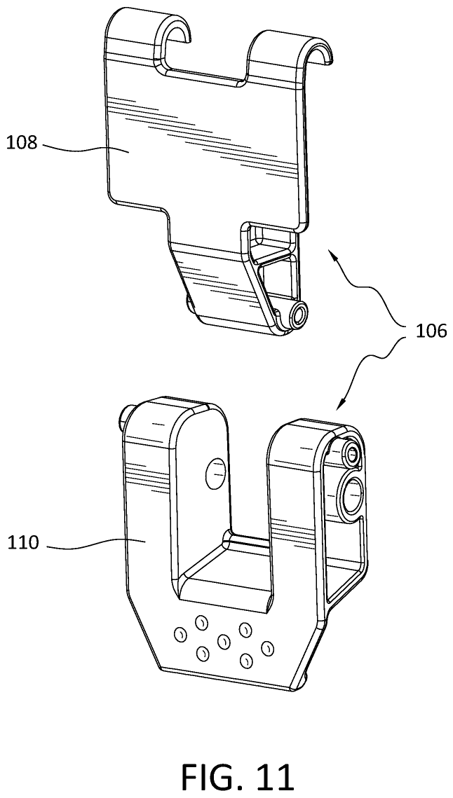

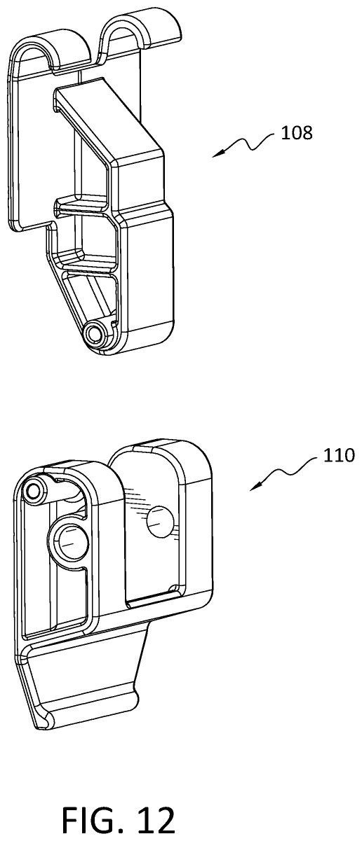

As shown in FIG. 1-12, some embodiments of the pin 114 may be configured so that the pin 114 only connects to a structure, such as the lid 102, at its ends 114b and 114c. When the pin 114 is thus configured and arranged, it may stand off some distance from other parts of the structure so that a space 116 is defined between the body of the pin 114 and those other parts.

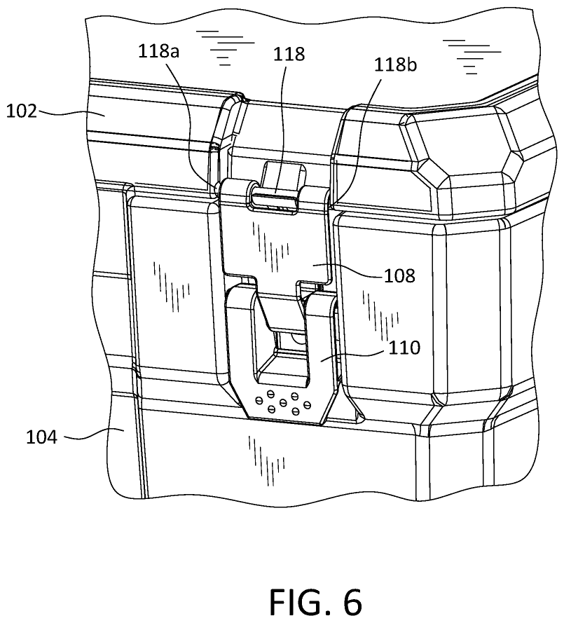

As further disclosed in FIG. 6, another embodiment of a pin 118 may be configured so that the pin 118 is attached to a structure, such as a land 120 of the lid 102, not only at the ends 118a and 118b of the pin 118, but also at a body portion of the pin 118. This construction and arrangement of the pin 118 and integral land 120 may lend strength, stiffness, and durability to the pin 118. As shown in the Figures, the land 120 may be omitted in some embodiments.

Any embodiment of any of the disclosed structures may comprise one or more pins with the configuration of pin 114 and/or one or more pins with the configuration of pin 118. Any of the pins disclosed herein may be integrally formed, whether by compression molding or blow molding, with a blow molded structure, such as the lid 102 for example.

In some embodiments, a structure such as the pin 114 and pin 118 may be reinforced. This reinforcement, which may comprise an element such as a steel rod for example, may be inserted into a pin, such as 114 or pin 118, before, during, or after a molding process.

B.2 Panel with Molded Pin

At least some example embodiments are directed to a pin such as may comprise an element of a structure, such as a panel for example. The pin may be configured to be received, possibly removably, in a corresponding recess defined by another structure, such as another panel for example. For example, a pin of one structure may be snap fit into a recess of another structure. Either of the structures may comprise one or more pins and/or one or more recesses. Two or more structures may thus be releasably connected to each other to define still further structures of various sizes and configurations. The pins included in such structures may be compression molded solid elements, or blow molded hollow elements. In any case, one or more pins may be integrally formed together with a structure, such as a panel, while the structure is being formed in a mold during a blow molding process. Where a pin is hollow, an interior of the pin may communicate with a hollow interior of the panel with which the pin is integrally formed.

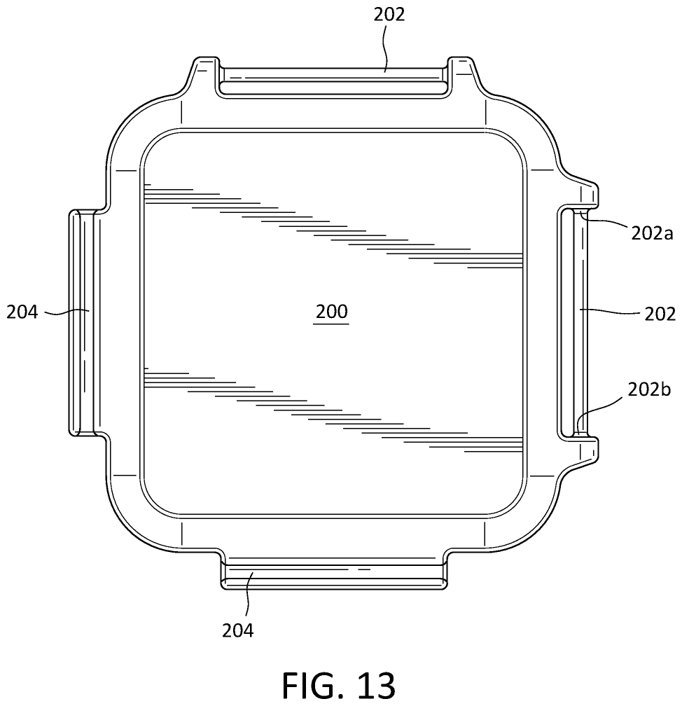

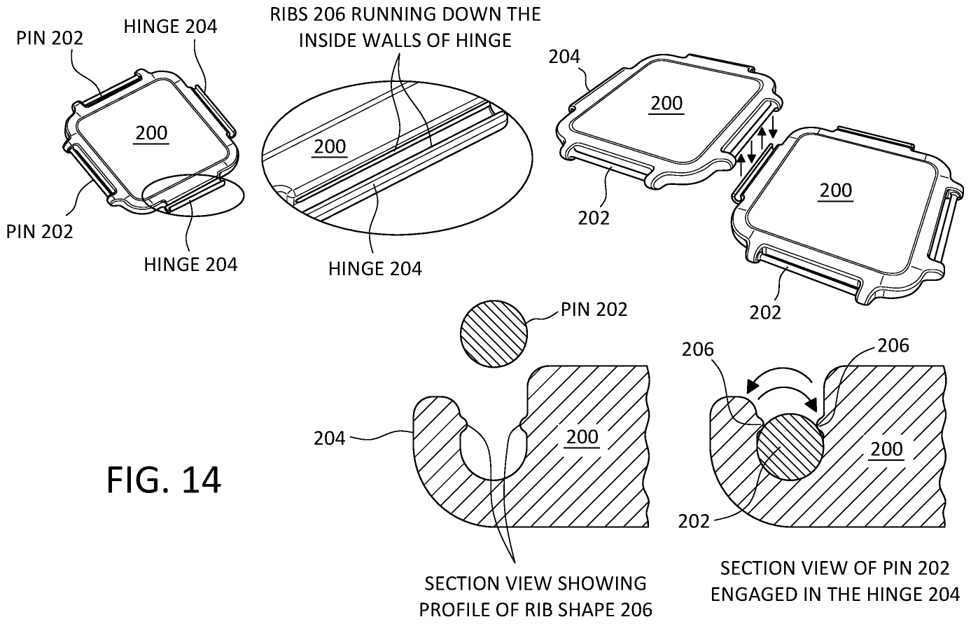

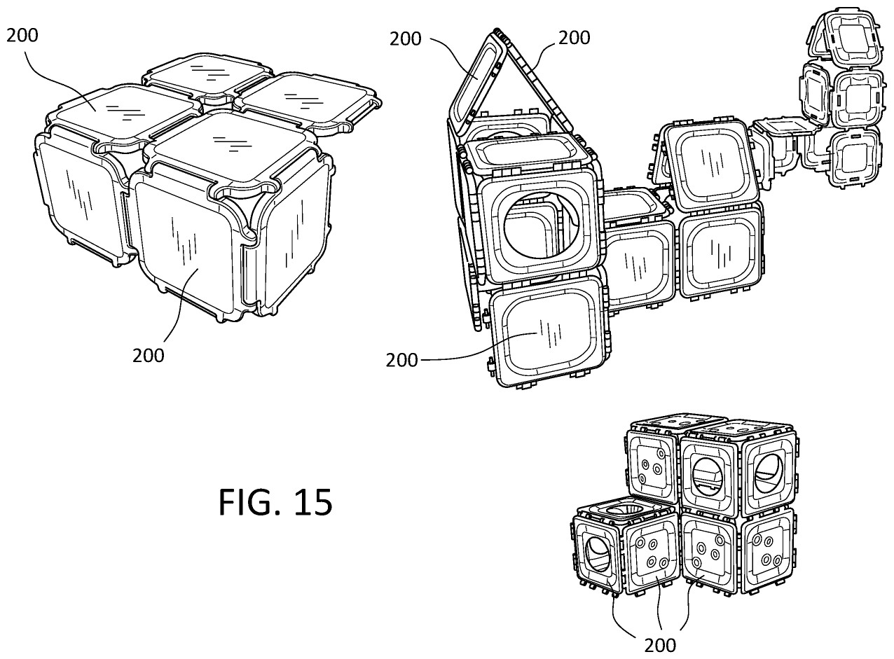

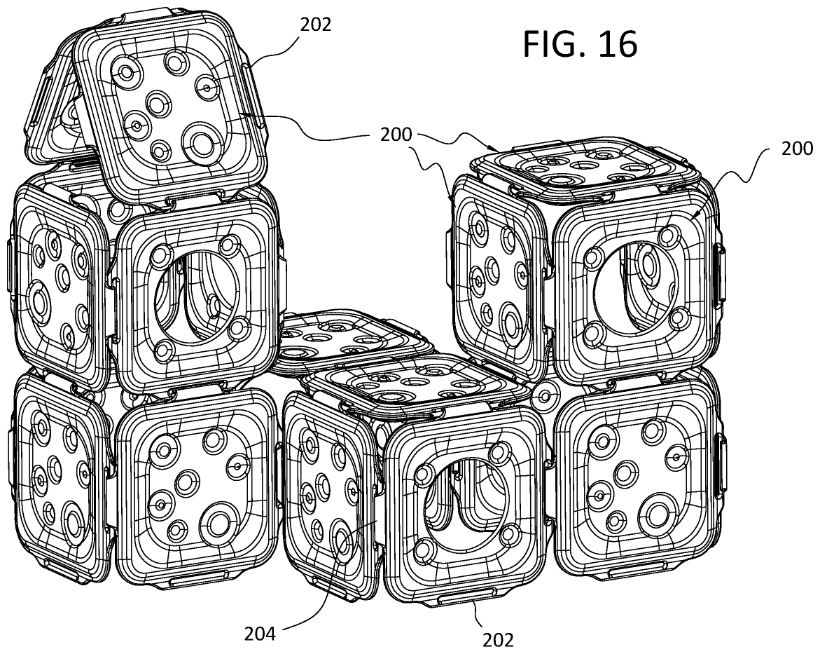

With reference now to FIGS. 13-16, further details are provided concerning an example embodiment of the invention. As shown in the Figures, a panel 200 is disclosed that may comprise one or more integral pins 202, and/or one or more integral hinges 204, which may also be referred to herein as ‘hinge portions.’ The panel 200 may be any shape, such as triangular, square, rectangular, polygonal, or any other shape. More generally, the panel 200 may take any shape that may enable the use of a pin and/or hinge such as are disclosed herein. One or more pins 202, or one or more hinge portions 204, may be positioned on any side, or sides, of the panel 200. A panel 200 may have one or more sides from which pins and hinge portions are omitted. The pin 202 and hinge 204 locations on a panel 200, or other structure, may enable multiple panels 200 to be releasably connected together at various different orientations, as shown in the examples of FIGS. 15 and 16.

In one particular example embodiment, a panel 200 may comprise two pins 202 positioned at about 90 degrees with respect to each other, and the panel 200 may further comprise two hinge portions 204 positioned at about 90 degrees with respect to each other. In this example embodiment, the pins 202 may be disposed on respective adjacent sides of the panel 200, and the hinge portions 204 may likewise be disposed on respective adjacent sides of the panel 200. However, no particular number, or arrangement, of hinge portions, or pins, is required in any embodiment.

In some embodiments of a panel 200, one or more pins 202 may be configured and arranged to stand off some distance from the main body of the panel 202 so that an open space is defined between the body of the pin 202 and the main body of the panel 200. In these embodiments, a pin 202 may be attached to the panel 200 only at the two ends 202a and 202b of the pin 202. A pin 202 need not be spaced apart from the main body of the panel 200, so long as the pin 202 can be fully received, without interference, in a hinge portion 204 of another panel 200. In some embodiments, the pin 202 may include a further, third, connection with the main body of the panel 200, and this third connection may be positioned at, or near, a midpoint of the length of the pin 202.

As further indicated in the Figures, a hinge portion 204 may comprise inwardly extending ribs 206 on either side of the hinge portion 204. A rib 206 may extend along all, or a majority of, a length of a hinge portion 204. In other embodiments, a rib 206 may have a segmented configuration that extends along all, or a majority of, a length of a hinge portion 204. While two ribs 206 are indicated in the Figures, more, or fewer, ribs 206 may be employed in other embodiments.

In general, the rib(s) 206 are configured and arranged to introduce an interference fit between a pin 202 and a hinge portion 204. However, due to the flexibility of the material of the hinge portion 204, rib 206, and pin 202, any or all of these elements may elastically deform as the pin 202 is pushed into position into the hinge portion 204. Likewise, any or all of these elements may elastically deform as the pin 202 is removed from the hinge portion 204. Once fully received by the hinge portion 204, the pin 202 may rotate freely within the hinge portion 204, and the structure of the hinge portion 204 may, alone or in cooperation with the main body of the panel 200, define a range of motion of the panels 200 that respectively comprise the pin 202 and the hinge portion 204.

In some embodiments, the range of motion of a panel 200, whose pin 202 is detachably received in a hinge portion 204 of another panel 200, relative to the other panel may be between about 0 degrees and about 90 degrees. Thus, two or more panels 200 may be positioned, relative to each other, to define configurations of a variety of different angles. Further, multiple panels 200 may be connected together to define a cube, or other rectangular volume.

As shown in the Figures, one or more panels 200 may include various features such as openings for example, although no panel is required to include any of such features. Further, the Figures disclose various example structures that may be created by attachment of multiple panels 200 together. Because the panels 200 may comprise hollow blow molded structures, they may be relatively easy to move, even when attached to multiple other panels 200. Further, once detached from each other, the panels 200 may be readily stacked together for easy transportation and storage.

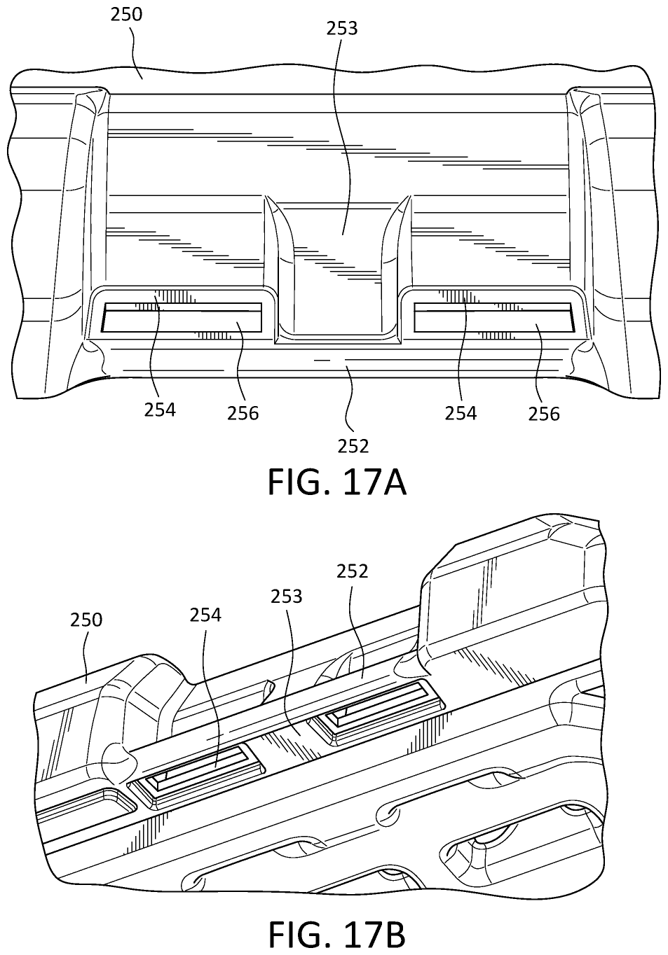

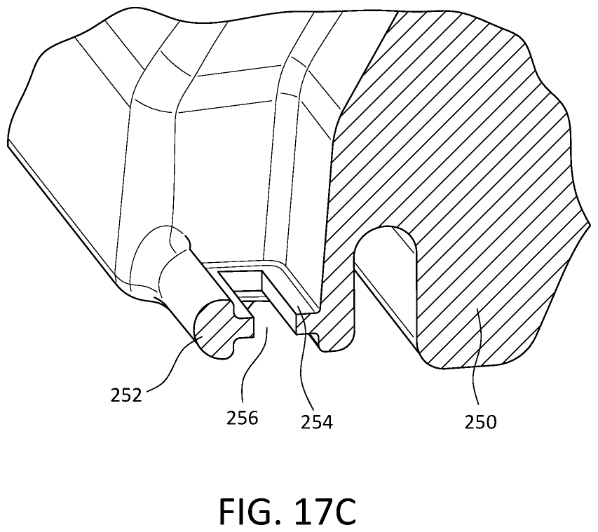

With reference finally to FIGS. 17a, 17b, and 17c, details are provided concerning one example alternative embodiment of the invention. In FIGS. 17a-17c, an apparatus 250, such as a box or cooler for example, is disclosed. The apparatus 250 includes a blow molded pin 252 that is integrally formed with the apparatus 250. The pin 252 may alternatively be a solid element created by compression molding, or other process. In contrast with another disclosed embodiment, the blow molded pin 252 is supported not only at its ends but in a middle portion of the blow molded pin 252, by an integral protruding portion 253, which may be hollow, of the apparatus 250. The protruding portion 253 may lend strength and stiffness to the blow molded pin 252, but is not necessarily required in any embodiment.

As also shown in the example of FIGS. 17a-17c, the apparatus 250 may comprise one or more flat land 254s that may each connect to the pin 252, and also define a respective opening 256. In an embodiment, the flat land(s) 254 may be implemented to enable the apparatus 250, which may comprise a lid or lid portion, to be punched while the apparatus 250 is still in a mold. The flat land(s) 254 need not be included in any embodiment.

C. Additional Example Embodiments

Following is a listing of additional example embodiments of the invention.
Embodiment 1. An apparatus, comprising: a blow molded structure with one or more parting lines, and the blow molded structure comprising: a body portion that is an integral part of the blow molded structure; and a pin that is integral with the body portion, and a portion of the pin is spaced apart from the body portion of the blow molded structure so that a space is defined between the portion of the pin and the body portion.
Embodiment 2. The apparatus as recited in embodiment 1, wherein the pin is a solid, compression molded, element that comprises a parting line.
Embodiment 3. The apparatus as recited in any of embodiments 1-2, wherein the pin is a hollow, blow molded, element.
Embodiment 4. The apparatus as recited in any of embodiments 1-2, wherein the blow molded structure is a lid configured to be detachably connected to a box.
Embodiment 5. The apparatus as recited in any of embodiments 1-4, wherein the blow molded structure is a panel configured to be detachable connected to another panel.
Embodiment 6. The apparatus as recited in any of embodiments 1-5, wherein the pin includes a first end and a second end, and the pin is attached to the body portion only at the first end and the second end.
Embodiment 7. The apparatus as recited in any of embodiments 1-6, further comprising a hinge portion that is configured to removably receive a pin of another structure and, when the pin is so received, the apparatus and the another structure are rotatable relative to each other.
Embodiment 8. The apparatus as recited in embodiment 7, wherein the hinge portion comprises one or more ribs configured and arranged for an interference fit with the pin of the another structure.
Embodiment 9. The apparatus as recited in any of embodiments 1-6, wherein the blow molded structure comprises a lid, and the apparatus further comprises a container body to which the lid is configured to be removably attached.
Embodiment 10. The apparatus as recited in embodiment 9, further comprising a land that is integral with the pin and with the lid.
Embodiment 11. The apparatus as recited in any of embodiments 9-10, further comprising a closure mechanism that is configured to releasably engage the pin.
Embodiment 12. The apparatus as recited in embodiment 10, wherein the closure mechanism comprises a latch configured to releasably engage the pin, and the latch is rotatably connected to a handle that is operable to selectively engage the latch with, and disengage the latch from, the pin.
Embodiment 13. The apparatus as recited in any of embodiments 9-12, further comprising a support element attached to the container body and configured for contact with the pin.

Although this disclosure has been described in terms of certain embodiments, other embodiments apparent to those of ordinary skill in the art are also within the scope of this disclosure. Accordingly, the scope of the disclosure is intended to be defined only by the claims which follow.

What is claimed is:

1. An apparatus, comprising:
a blow molded structure with one or more parting lines, and the blow molded structure comprising:
a body portion that is an integral part of the blow molded structure; and
a pin that is integral with the body portion, and a portion of the pin is spaced apart from the body portion of the blow molded structure so that a space is defined between the portion of the pin and the body portion.

2. The apparatus as recited in claim 1, wherein the pin is a solid, compression molded, element that comprises a parting line.

3. The apparatus as recited in claim 1, wherein the pin is a hollow, blow molded, element.

4. The apparatus as recited in claim 1, wherein the blow molded structure is a lid configured to be detachably connected to a box.

5. The apparatus as recited in claim 1, wherein the blow molded structure is a panel configured to be detachably connected to another panel.

6. The apparatus as recited in claim 1, wherein the pin includes a first end and a second end, and the pin is attached to the body portion only at the first end and the second end.

7. The apparatus as recited in claim 1, further comprising a hinge portion that is configured to removably receive a pin of another structure and, when the pin is so received, the apparatus and the another structure are rotatable relative to each other.

8. The apparatus as recited in claim 7, wherein the hinge portion comprises one or more ribs configured and arranged for an interference fit with the pin of the another structure.

9. The apparatus as recited in claim 1, wherein the blow molded structure comprises a lid, and the apparatus further comprises a container body to which the pin of the lid is configured to be removably attached.

10. The apparatus as recited in claim 9, further comprising a land that is integral with the pin and with the lid.

11. The apparatus as recited in claim 9, further comprising a support element attached to the container body and configured for contact with the pin.

12. The apparatus as recited in claim 9, further comprising a closure mechanism that is configured to releasably engage the pin.

13. The apparatus as recited in claim 12, wherein the closure mechanism comprises a latch configured to releasably engage the pin, and the latch is rotatably connected to a handle that is operable to selectively engage the latch with, and disengage the latch from, the pin.

14. A container, comprising:
a body that defines a volume; and
a blow-molded lid connected to the body by a hinge located on one edge of the blow-molded lid, and the blow-molded lid comprises:
a body portion that is an integral part of the blow molded structure; and
a pin that is integral with the body portion, and a portion of the pin is spaced apart from the body portion of the blow molded structure so that a space is defined between the portion of the pin and the body portion.

15. The container as recited in claim 14, further comprising a latch mechanism configured to releasably engage the pin.

16. The container as recited in claim 14, wherein the body comprises a unified, single-piece, structure.

17. The container as recited in claim 14, wherein the body comprises a hinge configured to be releasably engaged by the pin.

18. The container as recited in claim 14, wherein the pin is a solid, compression molded, element that comprises a parting line.

19. The container as recited in claim 14, wherein the pin is a hollow, blow molded, element.

20. The container as recited in claim 14, wherein the container comprises a box.

21. The container as recited in claim 14, wherein the pin includes a first end and a second end, and the pin is attached to the body portion only at the first end and the second end.

22. The container as recited in claim 14, wherein the pin comprises a vestigial element.
